(19) United States
(12) Patent Application Publication
(10) Pub. No.: US 2015/0092864 A1
(43) Pub. Date: Apr. 2, 2015

(54) METHOD OF SERVICE FOR PROVIDING MOVING IMAGE

(71) Applicant: JOCOOS, Seoul (KR)

(72) Inventors: Changhoon CHOI, Gyeonggi-do (KR); Wonsuk OH, Seoul (KR); Wongyo JUNG, Gyeonggi-do (KR); Beomseok OH, Seoul (KR); Sanghoon LEE, Seoul (KR)

(73) Assignee: JOCOOS, Seoul (KR)

(21) Appl. No.: 14/149,040

(22) Filed: Jan. 7, 2014

(30) Foreign Application Priority Data
Oct. 2, 2013 (KR) 10-2013-0118197

(51) Int. Cl. H04N 19/146; H04N 19/184

(52) U.S. Cl. CPC H04N 19/00169; H04N 19/00309
USPC 375/240.26

(57) ABSTRACT

Disclosed is a method of a service for providing a moving image. The method includes receiving a moving image from a user equipment, which subscribes to a service server, through a transmission/reception unit, by the service server providing the service for providing the moving image; extracting a bitrate value of the received moving image from the received moving image, by a bitrate extractor of the service server; comparing the extracted bitrate value with a reference value, by a bitrate converter of the service server; and encoding the received moving image so as to cause the bitrate value of the received moving image to become a preset bitrate conversion value and storing the encoded moving image in a memory unit of the service server, by the bitrate converter, when the extracted bitrate value exceeds the reference value.

### CROSS-REFERENCE TO RELATED APPLICATION

This application claims priority from and the benefit under 35 U.S.C. §119(a) of Korean Patent Application No. 10-2013-0118197, filed on Oct. 2, 2013, which is hereby incorporated by reference for all purposes as if fully set forth herein.

### BACKGROUND OF THE INVENTION

1. Field of the Invention

The present invention relates generally to a method of a service for providing a moving image. More particularly, the present invention relates to a method of managing a moving image, in which a service server which provides a service for providing a moving image stores an encoded moving image after encoding a moving image so as to cause a bitrate value of a moving image, which is included in moving image information transmitted by a user terminal, to become a preset bitrate conversion value, transmits the encoded moving image when a user makes a request, and thereby enables various types of user terminals to reproduce a moving image without separate encoding.

2. Description of the Prior Art

A bitrate signifies the speed of transmitting information of a digital signal, and a bitrate in a moving image signifies the rate of transmitting a screen per second In this case, such a bitrate in a moving image is expressed in kbps. The larger the value of a bitrate, the higher the image quality of a moving image. In contrast, the smaller the value of a bitrate, the lower the image quality of a moving image.

Recently, a portable device, such as a mobile communication terminal and the like, which can download a moving image from a web server, etc. and can reproduce the downloaded moving image, has been widely distributed, and types of display panels applied to the portable devices also have diversified. The portable device may be limited on the value of a bitrate of a moving image that the portable device can reproduce, depending on a resolution of the display panel applied to the portable device or the performance thereof. Specifically, the portable device cannot reproduce a moving image formed at a bitrate having a predetermined value or more, depending on the resolution of the display panel applied to the portable device or the performance thereof. The moving image that the portable device cannot reproduce goes through a separate encoding process so as to have a bitrate less than or equal to the value of a bitrate, at which the portable device can reproduce a relevant moving image, and thereby can be reproduced by the portable device.

However, in order to allow the portable device to reproduce a moving image downloaded from the web server and the like, a determination is made as to whether the moving image is reproduced. When the moving image is not reproduced, the bitrate of the moving image needs to be adjusted through the separate encoding process. Therefore, a problem arises in that it is inconvenient to reproduce a moving image by using the portable device.

### SUMMARY OF THE INVENTION

The present invention provides a method of a service for providing a moving image. An embodiment of the present invention provides a method of a service for providing a moving image, which enables various types of portable devices to reproduce a moving image downloaded from a web server and the like without a separate encoding process.

Objectives of the present invention are not limited to the above-mentioned objects, and other objects of the present invention can be clearly understood by those having ordinary knowledge in the technical field, to which the present invention pertains, from the following description.

In accordance with an aspect of the present invention, a method of a service for providing a moving image is provided. The method includes receiving a moving image from a user equipment, which subscribes to a service server, through a transmission/reception unit, by the service server providing the service for providing the moving image; extracting a bitrate value of the received moving image from the received moving image, by a bitrate extractor of the service server; comparing the extracted bitrate value with a reference value, by a bitrate converter of the service server; and encoding the received moving image so as to cause the bitrate value of the received moving image to become a preset bitrate conversion value and storing the encoded moving image in a memory unit of the service server, by the bitrate converter, when the extracted bitrate value exceeds the reference value.

Also, the method may further include storing the received moving image in the memory unit, by the bitrate converter, when the extracted bitrate value is less than or equal to the reference value.

Also, the method may further include, after the storing of the received moving image in the memory unit, transmitting the moving image matched to request information to the user terminal, by the service server, when the service server receives the request information on the moving image from the user terminal.

Further, the transmitting of the moving image matched to the request information to the user terminal may further include: generating a moving image list by using the moving image stored in the memory unit and transmitting the moving image list to the user terminal through the transmission/reception unit, by a control unit of the service server; and transmitting the moving image matched to the request information to the user terminal, by the service server, when the service server receives the request information on one of moving images included in the moving image list from the user terminal.

In addition, the reference value may be equal to 1000 kbps, and the bitrate conversion value may be less than or equal to 1000 kbps.

### BRIEF DESCRIPTION OF THE DRAWINGS

The above and other objects, features and advantages of the present invention will be more apparent from the following detailed description in conjunction with the accompanying drawings, in which:

FIG. 1 is a view for explaining a system for performing a method of a service for providing a moving image according to an embodiment of the present invention;

FIG. 2 is a block diagram schematically illustrating a configuration of a service server illustrated in FIG. 1; and

FIG. 3 is a flowchart illustrating a method of a service for providing a moving image according to an embodiment of the present invention.

### DETAILED DESCRIPTION OF THE EXEMPLARY EMBODIMENTS

The objectives, effects and technical configurations for achieving the objectives and effects of the present invention will be apparent with reference to embodiments of the present invention described in detail below in conjunction with the accompanying drawings. In the following description of the present invention, a detailed description of known functions and configurations incorporated herein will be omitted when it may unnecessarily obscure the subject matter of the present invention. The terms used in the following descriptions are defined in consideration of the corresponding structures, roles, functions, and the like in the present invention and thus the definitions of these terms may be changed depending on the intention or practice of a user and an operator.

However, the present invention is not limited to embodiments disclosed below, but can be implemented in various different forms. The embodiments are provided only to complete the disclosure of the present invention and fully convey the scope of the present invention to those having ordinary knowledge in the technical field, to which the present invention pertains. The scope of the present invention will be defined only by the appended claims. Therefore, the definitions of the terms must be determined based on the entire contents of the specification.

In the entire specification, when a certain part “comprises,” “includes,” or “has” a certain element, this indicates that the part does not exclude another element but may further include another element unless the context clearly indicates otherwise. In addition, the terms, “xxx unit,” “xxx module,” “xxx block,” and the like disclosed in the specification indicate a unit for processing at least one function or operation and may be implemented in hardware, software, or a combination thereof.

Meanwhile, in embodiments of the present invention, each element, each functional block, or each functional means may include one or more subordinate elements, and electrical, electronic and mechanical functions that each element performs may be implemented by various known devices, such as an electronic circuit, an integrated circuit and an Application Specific Integrated Circuit (ASIC) and the like, or by mechanical elements, and may be implemented as a separate element or may be integrated into a single unit.

Also, each block of the accompanying block diagram and each combination of steps of the accompanying flowchart may be performed by computer program instructions. The computer program instructions may be uploaded to a processor of a general-purpose computer, a special-purpose computer, or any other programmable data processing equipment. Accordingly, a means for performing functions described in each block of the accompanying block diagram or each step of the accompanying flowchart is generated by using the instructions executed by a processor of a computer or any other programmable data processing equipment. These computer program instructions may be stored in a computer-usable memory or a computer-readable memory which is oriented to a computer or any other programmable data processing equipment in order to implement functions in a particular manner. Accordingly, the computer program instructions stored in the computer-usable memory or the computer-readable memory can produce an article of manufacture including the instruction means for performing the functions described in each block of the accompanying block diagram or each step of the accompanying flowchart. These computer program instructions may also be loaded onto a computer or any other programmable data processing equipment. Accordingly, a series of operational steps are performed on the computer or some other programmable data processing equipment and generates computer-executable processes, so that instructions to run the computer or any other programmable data processing equipment can provide steps for performing the functions described in each block of the accompanying block diagram or each step of the accompanying flowchart.

Further, each block or each step may represent a part of a module, a segment or a code including one or more executable instructions for performing a specified logic function(s). For example, two successively illustrated blocks or steps may be substantially performed at the same time, or may be performed in reverse order depending on the relevant function.

Hereinafter, a method of a service for providing a moving image according to embodiments of the present invention will be described in detail with reference to the accompanying drawings.

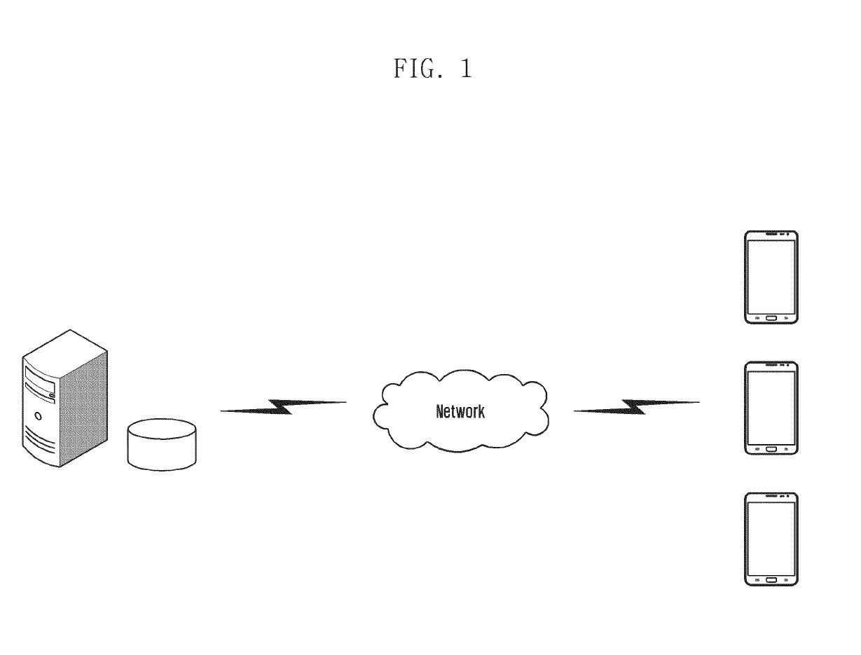

FIG. 1 is a view for explaining a system for performing a method of a service for providing a moving image according to an embodiment of the present invention.

Referring to FIG. 1, the system for performing the method of a service for providing a moving image includes a service apparatus 110 for providing a moving image and a user terminal 120. The service apparatus 110 for providing a moving image and the user terminal 120 wirelessly transmit/receive data, such as a moving image and the like, to/from each other through a network.

The service apparatus 110 for providing a moving image may be a service server which provides moving images that the user terminals 120 of various types can reproduce. Accordingly, hereinafter, for convenience of description, the service apparatus 110 for providing a moving image will be referred to as a “service server 110” and will be described as the service server 110.

The service server 110 receives a moving image transmitted by the user terminals 120, and extracts a bitrate value of the moving image. Also, the service server 110 compares the extracted bitrate value with a pre-stored reference value, stores a moving image having a bitrate value changed by selectively encoding the received moving image, and transmits the stored moving image to the user terminal 120.

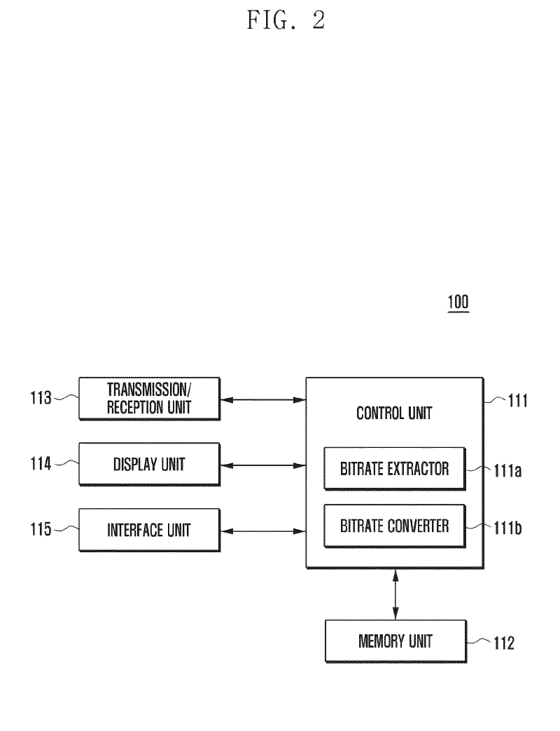

FIG. 2 is a block diagram schematically illustrating a configuration of a service server illustrated in FIG. 1.

Referring to FIG. 2, the service server 110 includes a control unit 111, a memory unit 112, a transmission/reception unit 113, a display unit 114, and an interface unit 115.

The control unit 111 controls an overall operation of the service server 110. The control unit 111 may include a bitrate extractor 111a, which extracts a bitrate value of a moving image transmitted by the user terminal 120, and a bitrate converter 111b which selectively encodes the received moving image by using the extracted bitrate value.

The memory unit 112 is electrically connected to the control unit 111, and stores an operating system, an application program, a reference value and a bitrate conversion value used to selectively encode a moving image transmitted by the user terminal 120, and the like.

The transmission/reception unit 113 is electrically connected to the control unit 111, receives a moving image and request information from the user terminal 120, and transmits a moving image matched to the received request information, which is selected by the control unit 111, to the user terminal 120.

The display unit 114 is electrically connected to the control unit 111, and displays various pieces of information, such as a bitrate value of a moving image, which has been extracted by the bitrate extractor 111a, and the like. The display unit 114 may be implemented by a Liquid Crystal Display (LCD), an Organic Light Emitting Diode (OLED) Display, and/or the like.

The interface unit 115 is electrically connected to the control unit 111, and may be implemented by a combination of input elements, such as a keyboard, a keypad, a touch screen and the like.

The user terminal 120 is a device used by each subscriber who subscribes to the service server 110, and examples of the user terminal 120 may include portable devices, such as a smart phone, a tablet Personal Computer (PC) and the like. However, embodiments of the present invention are not limited to this example. Hereinafter, for convenience of description, a description will focus on a case in which the user terminal 120 is a smart phone. The user terminal 120 transmits a moving image to the service server 110. Also, the user terminal 120 receives a moving image list from the service server 110, generates request information on one of moving images included in the moving image list, and transmits the generated request information to the service server 110. In response to the transmitted request information, the user terminal 120 receives a moving image matched to the transmitted request information from the service server 110, and reproduces the received moving image.

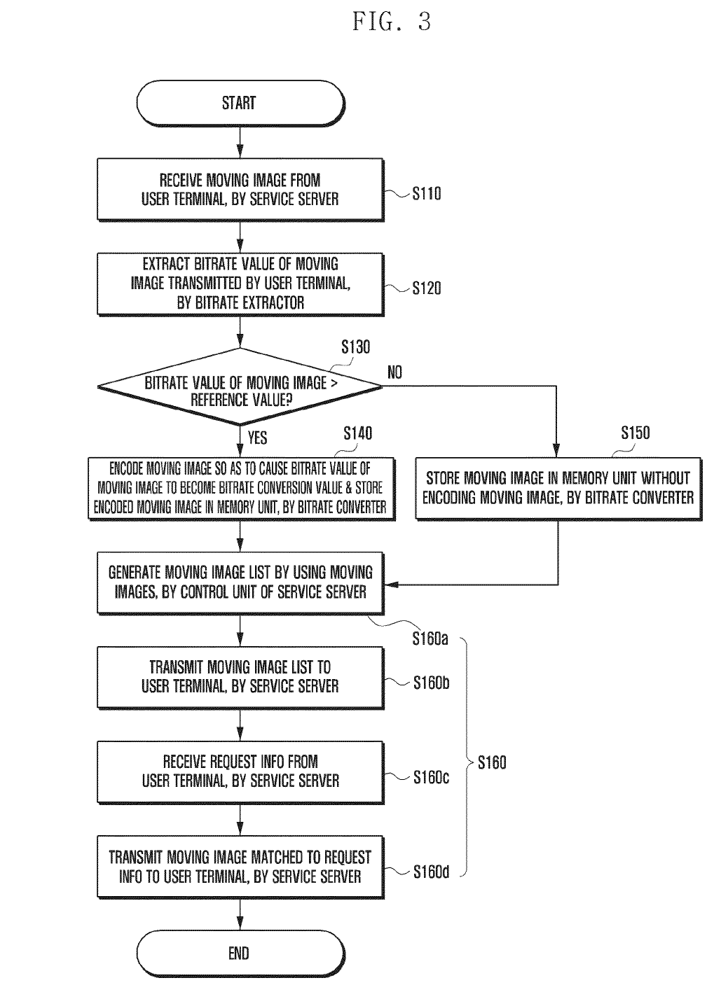

Hereinafter, referring to FIG. 3, which is a flowchart illustrating a method of a service for providing a moving image according to an embodiment of the present invention, a detailed description will be made of a method in which the service server 110 provides an encoded moving image to the user terminal 120. Meanwhile, the service server 110 receives a moving image transmitted by each of multiple user terminals used by multiple subscribers, extracts a bitrate value of the moving image transmitted by each of the multiple user terminals, and selectively encodes the moving images respectively transmitted by the multiple user terminals. Hereinafter, for convenience of description, a description will focus on a case in which the service server 110 provides the one user terminal 120 with a service for providing a moving image.

First, the service server 110 receives a moving image from the user terminal 120 through the transmission/reception unit 113, in step S110. At this time, before the service server 110 receives a moving image from the user terminal 120, the service server 110 may determine whether the user terminal 120 is a member subscribing to the service server 110. When the user terminal 120 is a member subscribing to the service server 110, the service server 110 receives a moving image from the user terminal 120, and proceeds with a service for providing a moving image. In contrast, when the user terminal 120 is not a member subscribing to the service server 110, the service server 110 requests the user terminal 120 to become a member by subscribing to the service server 110. When the user terminal 120 becomes a member by subscribing to the service server 110, the service server 110 receives a moving image from the user terminal 120, and proceeds with the service for providing a moving image.

Then, the bitrate extractor 111a of the service server 110 extracts a bitrate value of the moving image from the moving image transmitted by the user terminal 120, in step S120. The bitrate value of the moving image which has been extracted by the bitrate extractor 111a may be expressed by using a value of 1 to 2000 kbps. However, embodiments of the present invention are not limited to this example. Also, as the value of the bitrate extracted by the bitrate extractor 111a becomes larger, the image quality of the moving image transmitted to the service server 110 may be higher. However, embodiments of the present invention are not limited to this example.

Then the bitrate converter 111b of the service server 110 compares the extracted bitrate value with a reference value, in step S130. The reference value may be pre-stored in the memory unit 112 of the service server 110. In the present example, the reference value may be set to the largest value from among bitrate values of moving images that the user terminal 120 can reproduce without a separate encoding process. In other words, the reference value may be the largest value from among bitrate values of moving images that the user terminal 120 can reproduce regardless of the performance of the user terminal 120. For example, the reference value may be set to 1000 kbps which is the largest value from among bitrate values of moving images that the user terminal 120 can reproduce without a separate encoding process. However, embodiments of the present invention are not limited to this example.

When the bitrate value of the moving image exceeds the reference value, in step S140, the bitrate converter 111b encodes the moving image so as to cause the bitrate value of the moving image to become a preset bitrate conversion value, and stores the encoded moving image in the memory unit 112 of the service server 110. The bitrate conversion value may be pre-stored in the memory unit 112, and may be set to be less than or equal to the reference value. For example, when the reference value is set to 1000 kbps, the bitrate conversion value may be set to one of values less than or equal to 1000 kbps. However, embodiments of the present invention are not limited to this example. In other words, the bitrate value of the moving image encoded by the bitrate converter 111b may be less than or equal to 1000 kbps. As described above, the reference value is set to the largest value from among bitrate values of moving images that a portable device can reproduce without a separate encoding process, the bitrate conversion value is set to be less than or equal to the reference value, and the bitrate value of the moving image is equal to the bitrate conversion value. Accordingly, a moving image, which is matched to request information that the service server 110 as described below has transmitted to the user terminal 110 through the transmission/reception unit 113, may have a bitrate value less than or equal to 1000 kbps. As a result, in order to use the user terminal to reproduce a moving image that the user has received from the service server 110 through the user terminal 120, the user does not need to encode the received moving image. In other words, it is possible to simplify a process in which the user terminal 120 reproduces a moving image transmitted by the service server 110.

Meanwhile, when the bitrate value of the moving image is less than or equal to the reference value, in step S150, the bitrate converter 111b stores the moving image in the memory unit 112 without encoding the moving image. In other words, the service server 110 allows the bitrate values of all of the moving images stored in the memory unit 112 to be less than or equal to 1000 kbps.

When the service server 110 receives request information on a moving image from the user terminal 120, in step S160, the service server 110 transmits the moving image matched to the request information to the user terminal 120. Specifically, in step S160a, the control unit 111 of the service server 110 generates a moving image list by using moving images stored in the memory unit 112. As described above, in the method of a service for providing a moving image according to embodiments of the present invention, moving images transmitted by multiple user terminals may be received, and thus the moving image list may include multiple moving images.

In step S160b, the service server 110 transmits the moving image list to the user terminal 120 through the transmission/reception unit 113. When the user terminal 120 receives the moving image list, the user terminal 120 displays the moving image list through a display unit (not illustrated) included in the user terminal 120.

When one image is selected from among moving images included in the moving image list through an interface unit (not illustrated) included in the user terminal 120, the user terminal 120 generates request information. In the present example, the moving images included in the moving image list may include not only a moving image transmitted from the user terminal 120 to the service server 110 but also another moving image transmitted from another terminal used by another user to the service server 110. In other words, the user who uses the user terminal 120 can easily identify not only a moving image that the user has transmitted to the service server 110 but also another moving image that another user has transmitted to the service server 110. The user terminal 120 transmits the generated request information to the service server 110.

The service server 110 receives the request information from the user terminal 120 in step S160c, extracts a moving image matched to the request information from the memory unit 112, and transmits the extracted moving image to the user terminal 120 in step S160d. In the present example, the moving image transmitted to the user terminal 120 may have a bitrate value less than or equal to 1000 kbps. Specifically, a moving image transmitted from the user terminal 120 to the service server 110 and another moving image transmitted from another terminal used by another user to the service server 110 may be stored so as to have bitrate values less than or equal to 1000 kbps. Accordingly, the user terminal 120 receives a moving image having a bitrate value less than or equal to 1000 kbps from the service server 110, and can easily reproduce the received moving image.

In the method of a service for providing a moving image according to embodiments of the present invention, the bitrate converter of the service server compares a bitrate value of a received moving image with a reference value. When the bitrate value of the received moving image exceeds the reference value, the bitrate converter of the service server encodes the received moving image so as to cause the bitrate value of the received moving image to become a preset bitrate conversion value less than or equal to 1000 kbps, and stores the encoded moving image. Then, the service server transmits the encoded moving image to the user terminal. Therefore, each of the user terminals of various types can reproduce a moving image provided by the service server without a separate encoding process.

The effects of the present invention are not limited to the above and other effects that are not mentioned can be clearly understood by those having ordinary knowledge in the technical field, to which the present invention pertains, from the following description.

Although the embodiments of the present invention have been described hereinabove, those having ordinary knowledge in the technical field of the present invention will appreciate that various changes and modifications may be made to the embodiments described herein by the addition, modification, removal and the like of elements without departing from the scope and spirit of the present invention as disclosed in the accompanying claims. However, the various changes and modifications are to be construed as being included within the right scope of the present invention.

What is claimed is:

1. A method of a service for providing a moving image, the method comprising:
receiving a moving image from a user equipment, which subscribes to a service server, through a transmission/reception unit, by the service server providing the service for providing the moving image;
extracting a bitrate value of the received moving image from the received moving image, by a bitrate extractor of the service server;
comparing the extracted bitrate value with a reference value, by a bitrate converter of the service server; and
encoding the received moving image so as to cause the bitrate value of the received moving image to become a preset bitrate conversion value and storing the encoded moving image in a memory unit of the service server, by the bitrate converter, when the extracted bitrate value exceeds the reference value.

2. The method of claim 1, further comprising storing the received moving image in the memory unit, by the bitrate converter, when the extracted bitrate value is less than or equal to the reference value.

3. The method of claim 2, further comprising, after the storing of the received moving image in the memory unit, transmitting the moving image matched to request information to the user terminal, by the service server, when the service server receives the request information on the moving image from the user terminal.

4. The method of claim 3, wherein the transmitting of the moving image matched to the request information to the user terminal further comprises:
generating a moving image list by using the moving image stored in the memory unit and transmitting the moving image list to the user terminal through the transmission/reception unit, by a control unit of the service server; and
transmitting the moving image matched to the request information to the user terminal, by the service server, when the service server receives the request information on one of moving images included in the moving image list from the user terminal.

5. The method of claim 1, wherein the reference value is equal to 1000 kbps, and the bitrate conversion value is less than or equal to 1000 kbps.
